(19) United States
(12) Patent Application Publication
(10) Pub. No.: US 2008/0311082 A1
(43) Pub. Date: Dec. 18, 2008

(54) Process for Treating Animal Waste

(76) Inventors: Kishore Murthy, Ottawa (CA); Rainer Englehardt, Ottawa (CA)

Correspondence Address: BRINKS, HOFER, GILSON & LIONE, 2801 SLATER ROAD, SUITE 120, MORRISVILLE, NC, 27560, US

(21) Appl. No.: 11/915,281

(22) PCT Filed: May 26, 2006
(86) PCT No.: PCT/CA2006/000863

§ 371 Date: May 19, 2008

Related U.S. Application Data
(60) Provisional application No. 60/685,116, filed on May 26, 2005.

(51) Int. Cl. A01N 63/00; A01P 1/00

(52) U.S. Cl. 424/93.6

(57) ABSTRACT

The present invention is directed to a process for reducing a population of one, or more than one target pathogen present in animal waste, including livestock manure , comprising administering one, or more than one protected bacteriophage strain to livestock. The one, or more than one bateriophage strain is capable of adsorbing to and killing the target pathogen, is released in vivo, and acts to clear the one or more than one pathogen from livestock gut and waste. The one, or more than one bacteriophage it further reduces the population of the one or more than one target pathogen in the waste or manure. The present invention also relates to a process for reducing a population of one, or more than one target pathogen present in liquid manure comprising treating the animal waste such as liquid manure with one, or more than one protected bateriophage strain, or phage components, or a combination thereof.

The present invention relates to a process for reducing bacterial load within an animal and for treating liquid manure or other waste of animal origin.

### BACKGROUND OF THE INVENTION

Manure represents a significant amount of biological waste generated by animal holding facilities, including farms and aquaculture systems, throughout the world. The total amount of livestock manure produced in the US is in the range of 1.4 billion tons/year, with cattle contributing over 90%. An estimate for manure production in Canada is 132 million tons/year, with cattle (beef and dairy) and calves contributing 78% of the total. There are four major regional clusters of intense cattle farming, three of these regions being in Ontario.

However, manure generated by livestock is a major contributor to contamination of the environment by E. coli O157:H7, Campylobacter, Salmonella and other pathogens carried by livestock. For example, Zhao et al (Appl Env Microbiol (1995) 61, 1290-1293) showed that 4.9-5.3% of weaned calves shed E. coli O157:H7 in feces, and that 22% of the control herds were positive for the pathogen. Feces from infected animals could contaminate food, food products, ground water or well water, posing a risk for human infection.

Livestock manure is a major source of coliform bacteria in the soil, due to its use as a fertilizer for agricultural crops and grazing lands. Heavy rainfall is associated with contamination of well water, lakes and streams by livestock manure contaminated with the subject pathogens. For example, source water contamination by run-offs from a cattle farm was determined to be the major cause of the serious E. coli O157:H7/Campylobacter jejuni outbreak at Walkerton, Ontario, Canada in May 2000.

A spatial relationship between livestock density and human Shiga toxin-producing E. coli (STEC) incidence has been clearly demonstrated in a study done in Ontario between 1990 and 1995. This would also hold good in similar high intensity farming clusters in the United States and around the world. There is also evidence that cattle density has a positive association with STEC incidence, correlating with a higher STEC infection rate in rural Ontario. In fact, Southern Ontario and Quebec have recorded some of the highest concentrations of coliforms.

In order to counter environmental contamination and to eliminate pathogens from manure, guidelines for the utilization of animal wastes on land were revised by the Commission of the European Communities in 1981 (Communicable diseases resulting from storage, handling, transport and landspreading of manures. J. R. Walton and E. G. White (eds), Office of Publications of the European Community, Luxemburg). Recommendations included the storage of animal wastes for 60 days during summer and 90 days during winter prior to land application, which would allow sufficient time for the elimination of the pathogens. Several bacterial pathogens have been shown to persist for prolonged periods of time in manure heaps causing contamination of the fields when spread.

These types of findings underline the importance of treating animal wastes prior to land application as fertilizer. U.S. Pat. No. 5,965,128 (Doyle et al. see also Zhao et al (1998) J Clin Microbiol, 36, 641-647) teaches the use of probiotic bacteria to reduce or prevent the carriage of E. coli O157:H7 in cattle. However, the method taught by U.S. Pat. No. 5,965,128 is highly invasive and involves inoculation of cattle via rumen cannulation. Such a method does not provide a convenient method that is relevant to livestock rearing and management practices of administration of the probiotic bacteria.

Bacteriophages have also been considered for use in treatment of animal wastes. Bacteriophages (or “phages”) are bacterial viruses that specifically infect and kill bacteria, and are widely distributed in nature. Phages recognize receptors on the bacterial surface, attach to them and inject their genetic material into the host cell. They degrade the host bacteria's DNA and synthesize their own genetic material and required coat proteins, then assemble new virus particles before bursting the cell. The released bacteriophages will then infect and destroy additional bacteria in the surrounding environment. This process continues until most of the host bacteria are eliminated from the system.

Smith et al (J Gen Microbiol (1987) 133, 1111-1126) have shown that phages may be useful in controlling enterotoxigenic E. coli infections in livestock. The study showed that strain-specific phages could cure or prevent E. coli diarrhea in calves by a single oral dose, or by spraying of the litter with phages. However, the phages were only efficient if administered prior to or simultaneously with administration of E. coli. The pathogen used by Smith et al is distinct from E. coli O157:H7, and the phages found to be effective in this study will not recognize E. coli O157:H7.

Kudva et al (Appl Env Microbiol (1999) 65, 3767-3773) showed that phages were efficient in reducing the amount of or clearing E. coli O157:H7 from cultures, as no single phage could clear an E. coli O157:H7 culture. A mixture of three O157-specific phages was capable of eliminating the bacteria from cultures. There is no teaching that such phages would be efficient in controlling E. coli O157:H7 in vivo in livestock.

U.S. Pat. No. 6,485,902 (Waddell et al) teaches the use of specific bacteriophages to reduce the levels of E. coli O157:H7 in the gastrointestinal tract of cattle. A mixture of 6 phages was administered orally, in high dosages to calves prior to and after challenge with E. coli O157:H7. The shedding of E. coli O157:H7 in feces was reduced by approximately half in treated calves compared to calves not receiving phages. However, high dosages were required, indicating that a large number of bacteriophages were being inactivated within the gastrointestinal tract.

Livestock manure is a valuable commodity that is presently underused due to the presence of pathogens, such as E. coli O157:H7, Campylobacter, Salmonella and the like, contaminating the manure. These bacterial pathogens may lead to food-borne illnesses caused by eating contaminated meat or agricultural produce. In addition, spreading pathogen infested manure on the fields leads to contamination of source water during heavy rains. Despite advances in the treatment of animal wastes, current methods do not provide convenient, efficient and dependable reduction of the pathogen content.

### SUMMARY OF THE INVENTION

The present invention relates to a process for reducing bacterial load within an animal and for treating liquid manure or animal waste.

It is an object of the present invention to provide a process for treating liquid manure or animal waste.

The present invention provides a process for reducing a population of one, or more than one target pathogen present in livestock manure comprising, administering one, or more than one protected bacteriophage strain, or phage component, to an animal, where the one, or more than one bacteriophage strain, or phage component is released in vivo, is capable of killing the one or more than one target pathogen, and acts to clear the one or more than one pathogen from a gut of the animal thereby reducing the population of one, or more than one target pathogen present in animal waste, for example livestock manure.

In the process as described above, the one, or more than one protected bacteriophage strain, or phage components, may be administered in a treatment dosage of about 10⁷ to about 10¹³ pfu/animal/day. Alternatively, the one, or more than one encapsulated immobilized bacteriophage strain, or phage components, may be administered in a maintenance dosage of about 10⁵ to about 10⁹ pfu/animal/day. In yet another alternative, the one, or more than one encapsulated immobilized bacteriophage strain, or phage components, may initially be administered in a treatment dosage of about 10⁷ to about 10¹³ pfu/animal/day, followed by a maintenance dosage of about 10⁵ to about 10¹⁰ pfu/animal/day.

The present invention also pertains to the method as described above wherein the animal waste, such as liquid manure or livestock manure, is also treated ex vivo with an additional dosage of one, or more than one bacteriophage strain, or phage components. For example, the one, or more than one bacteriophage strain, or phage components, may be added to the manure while the manure is being liquefied, while the liquefied manure is being pumped, while the liquefied manure is in a storage tank or lagoon, or any combination thereof. The one, or more than one bacteriophage strain, or phage components, may also be added in the treatment of fecal waste from poultry and aquaculture operations.

Also provided by the present invention is a process for reducing a population of one, or more than one target pathogen present in animal waste such as liquid manure, comprising, providing one, or more than one protected bacteriophage strain, or phage component, to the animal waste for a sufficient time period where the one, or more than one protected bacteriophage strain, or phage component is released within the animal waste such as liquid manure and kills the one or more than one target pathogen, thereby reducing the population of one, or more than one target pathogen in the animal waste such as livestock manure.

The present invention also pertains to the process just described, where the one, or more than one bacteriophage strain, or phage components, is added to the liquid manure while the liquid manure is being pumped, while the liquid manure is in a holding reservoir, or both while the liquid manure is being pumped and while it is in a holding reservoir. Furthermore, the one, or more than one bacteriophage strain, or phage components, may be added to the animal waste within a holding tank.
The present invention also pertains to the process just described, where the one, or more than one bacteriophage strain, or phage components, is added to the liquid manure or animal waste at an amount between about 10⁵ to about 10¹⁰ pfu/gram.

The present invention also provides a process for preventing the spread of infections in an animal caused by one or more than target pathogen. The process comprises administering one or more than one bacteriophage strain, phage component, or both, to the animal, such that the one, or more than one bacteriophage strain, phage component, or both, is released within the digestive tract of the animal, attach to and kill the target pathogen, thereby reducing the population of the one or more than one target pathogen within animal waste. The target pathogen may be E. coli O157:H7, Staphylococcus aureus, Treponema, or another pathogen carried in the gastrointestinal tract, or a combination thereof. The one or more than one bacteriophage strain, phage component, or both, may be provided as a controlled release bacteriophage strain, phage component, or both.

The use of bacteriophages for reducing pathogenic bacteria within an animal, within liquid manure, and within animal waste will help reduce the population of pathogenic bacteria within manure or animal waste that may be used to fertilize agricultural fields. This will assist in reducing contamination of ground water and well water, and reduce pathogenic populations within livestock and other animal or human populations thereby assisting in maintenance of livestock, animal or human populations. Furthermore, bacteriophages against pathogens can be applied to the animal waste such as manure without affecting the beneficial flora in the soil and the eco system.

This process overcomes the disadvantages of the prior art by treating animal waste such as liquid manure in a controlled fashion, prior to its application as a fertilizer in agricultural applications. The bacteriophages used in this process have been confirmed to be safe, and to lack toxins. These highly efficacious and safe bacteriophages show great advantages over those of the prior art in manure treatment applications.

Therefore, the invention offers significant advances in the treatment of liquid manure. This summary of the invention does not necessarily describe all necessary features of the invention.

### BRIEF DESCRIPTION OF THE DRAWINGS

These and other features of the invention will become more apparent from the following description in which reference is made to the appended drawings wherein:

FIG. 1 shows the titer of phage applied to the skim milk powder (Before) and that obtained after immobilization and resuspension (After).

FIG. 2 shows the titer of phage applied to the soya protein powder (Before) and that obtained after immobilization and resuspension (After).

FIG. 3 shows the effect of encapsulation on bacteriophage activity. Phage titers before and after encapsulation are shown.

FIG. 4A shows the effect of low pH on the stability of encapsulated phages. Encapsulated phage titers were determined before and after grinding. All phage concentrations have been corrected for the weight of encapsulated material. FIG. 4B shows the effect of low pH on the infectivity of phage. The phages were neither immobilized nor encapsulated.

FIG. 5 shows stability of encapsulated immobilized phages over a period of 4.5 months (131 days) and 10 months (311 days) when stored at room temperature (RT) or at 4° C.

FIG. 6 shows the level of bacteriophages shed in the manure of phage-treated animals over a period of 11 days.

FIG. 7A and 7B show the E. Coli O157:H7 level in control samples incubated at room temperature and at 4° C., respectively, as a function of time. FIG. 7C and 7D show the E. coli O157:H7 level in manure treated with bacteriophages 10⁵ pfu/ml and incubated at room temperature and at 4° C., respectively.

FIG. 8A shows the total E. coli level in control manure samples and manure samples treated with bacteriophages at 10⁵ cfu/ml over 7 days. FIG. 8B shows the E. coli O157:H7 level in control manure samples and manure samples treated with bacteriophages at 10⁵ pfu/ml over 7 days.

FIG. 9 shows the E. coli O157:H7 level in control manure samples and manure samples treated with bacteriophages 10⁸ pfu/gm over 18 days.

FIG. 10 shows the total E. coli count in control manure samples and manure samples treated with bacteriophages at 10⁸ pfu/gm over 18 days.

### DESCRIPTION OF PREFERRED EMBODIMENT

The present invention relates to a process for reducing bacterial load within an animal and as a consequence, reducing the pathogen load in the environment by reduced pathogen counts in the manure or waste from these animals. Methods for treating liquid manure or waste directly are also presented.
The following description is of a preferred embodiment.

The present invention provides a process for reducing a population of one, or more than one target pathogen present in livestock manure comprising, administering one, or more than one protected, immobilized bacteriophage strain, or phage component, or both, to an animal, where the one, or more than one bacteriophage strain, phage component, or both is released in vivo, is capable of killing the one or more than one target pathogen, and acts to clear the one or more than one pathogen from the gut of the animal. The one, or more than one bacteriophage strain, or phage components, or both, may also be passed through the animal and into the livestock manure, where it may further reduce the population of the one or more than one target pathogen in the manure. The bacteriophages may comprise one, or more than one strain of bacteriophage, or phage component, or both, that is capable of infecting the same or different target pathogens.

The present invention also provides a process for reducing a population of one or more than one target pathogen present in animal waste such as liquid manure comprising, treating a primary holding tank comprising the animal waste such as liquid manure with the one, or more than one bacteriophage strain, or phage components, or both, where the one, or more than one bacteriophage strain, or phage components, or both, capable of adsorbing to, and killing, the target pathogen.

The present invention further provides a method for reducing a population of one, or more than one target pathogen present in a livestock operation comprising, providing one or more than one protected bacteriophage strain, or phage component, or both to animal feed, to an animal, to animal waste, such as liquid manure, or a combination thereof, wherein the one, or more than one protected bacteriophage strain, or phage component, or both, is released within the animal feed, the animal, the animal waste, such as liquid manure, or a combination thereof, and kills the one or more than one target pathogen, thereby reducing the population of one, or more than one target pathogen in the livestock operation. A livestock operation may include, but is not limited to animals for agricultural use such as, but not limited to dairy cattle, beef cattle, bison, horses, sheep, goat, swine, poultry including chickens and turkeys, and the like. In the context of the present invention, a livestock operation may also include open or closed aquaculture systems for fish, shellfish, and the like, as well as animals in a zoo or petting zoo. This method reduces the population of target pathogens within the barn and surrounding areas within a livestock operation.

The bacteriophages may comprise one, or more than one strain of bacteriophage, or phage components, or both (also referred to as as “bacteriophages and/or phage components) that are capable of infecting the same or different target pathogens. Furthermore, the bacteriophage, or phage components, or both may be protected, or comprise a combination of un-protected and protected bacteriophage, or phage components, or both.

If desired, a cocktail of bacteriophages strains, phage components, or both, may be used against a single bacterial target, or multiple bacterial targets. By the term “target pathogen”, it is meant pathogenic bacteria that may cause illness in humans, animals, fish, birds, or plants. The target pathogen may be any type of bacteria, for example but not limited to the bacterial species and strains of, Escherichia coli, Streptococci, Humicola, Salmonella, Campylobacter, Listeria, Lawsonia, Staphylococcus, Pasteurella, Mycobacterium, Hemophilius, Helicobacter, Mycobacterium, Mycoplasmi, Nesseria, Klebsiella, Enterobacter, Proteus, Bactercides, Pseudomas, Borrelius, Citrobacter, Propionobacter, Treponema, Shigella, Enterococcus, Leptospirex, Bacillii including Bacillus anthracis and other bacteria pathogenic to humans, animals, fish, birds, or plants. Of particular interest are bacteria that also infect livestock, including but not limited to cattle, swine, and poultry destined for human consumption, for example but not limited to Salmonella, Campylobacter and E. coli O157:H7, or any combination thereof. In another non-limiting example, the target pathogen may be E. coli, Staphylococcus Treponema, or any combination thereof.

The term “animal waste” indicates any waste any type of waste created by animals in a holding system. Animal waste may include, but is not limited to livestock manure, liquid manure, fecal waste, and the like. By the term “livestock manure”, it is meant manure produced by animals for agricultural use. Animals for agricultural use may include, but are not limited to dairy cattle, beef cattle, bison, horses, sheep, goat, swine, poultry including chickens and turkeys, and the like. By the term “liquid manure” or “liquefied manure”, it is meant livestock manure that is in a substantially liquid form. Liquid manure usually includes manure, urine, water, detergents and other chemicals used to clean and sanitize the barn floor. Liquid manure may be held in a primary storage tank, primary storage pit, primary holding tank, a portable tank, or the like, for varying lengths of time, for example from about a part of a day to several days, or weeks, prior to being pumped into a secondary storage facility or lagoon. “Fecal waste” includes all other waste produced by animals, for example, but not limited to waste obtained from aquaculture, or animals in a zoo or petting zoo. A person of skill in the art would understand that fecal waste may include water, urine, and chemicals used for cleaning. It is also to be understood that one or more than one bacteriophage and/or phage components may also be applied to animal waste in order to reduce or eliminate pathogens within ground water and when used as a fertilizer, as night soil.

The term “bacteriophage” or “phage” is well known in the art and generally indicates a virus-like parasite that infects bacteria. Phages are parasites that multiply inside bacterial cells by using some or all of the host's biosynthetic machinery, and can either be lytic or lysogenic. The bacteriophages used in accordance with the present invention may be any bacteriophage that is effective against a target pathogen of interest. However, the bacteriophages for use in the present invention should be selected to be non-lysogenic, which means the phage DNA is not capable of incorporating into the host's genomic DNA. Similarly, the phage components may comprise any phage components including, but not limited to the tail, or a phage protein that is effective against a target bacteria of interest. If desired, a cocktail of bacteriophages and/or phage components may be used against a single target pathogen, or multiple target pathogens.

The bacteriophages, or phage components, or both, may be provided in an aqueous solution. The aqueous solution may be any solution suitable for the purpose of the present invention. For example, the bacteriophages, or phage components, may be provided in water or in an appropriate medium as known in the art, for example LB broth, SM, TM, PBS, TBS or other common buffers as is known in the art (see for example, but not limited to Maniatis et al (1982) Molecular cloning: a laboratory manual, Cold Spring Harbor Laboratory, Cold Spring Harbor, N.Y. which is incorporated herein by reference). For example, but without wishing to be limiting, the bacteriophages may be stored in LB broth.

The bacteriophages, or phage components, may also be provided immobilized onto a matrix. By the term “matrix”, it is meant any suitable solid matrix that is soluble in water, ingestible by a mammal, or both soluble in water and ingestible by a mammal. The matrix may be non-water-soluble, provided that any absorbed phages can be released from the matrix when desired. The matrix should be capable of adsorbing the bacteriophages, and/or phage components, onto its surface and releasing the bacteriophages, or phage components, in an appropriate environment. The bacteriophages, or phage components, or both, should not adhere so strongly to the matrix that they cannot be released upon appropriate re-suspension in a medium. Preferably, the adsorbed, immobilized, bacteriophages, or phage components, are non-covalently associated with the matrix so that they may be released from the matrix when desired. Non-limiting examples of a matrix that may be used according to the present invention include skim milk powder, soya protein powder, albumin powder, single cell proteins, trehalose, mannitol or other powdered sugar or sugar alcohol, charcoal, or latex beads, synthetic plant-derived plastic, such as but not limited to corn plastic, soya plastic, and the like, compounds used in the formulation of time released tablets as described below, or other inert surfaces. Preferably, the matrix is generally regarded as safe (GRAS).

The bacteriophages, and/or phage components, in aqueous solution may be applied to the matrix by any method known in the art, for example dripping or spraying, provided that the amount of the matrix exceeds the amount of aqueous bacteriophage, and/or phage components, solution. It is preferred that the matrix remain in a dry or semi-dry state, and that a liquid suspension of bacteriophages (and/or phage components) and matrix is not formed. Of these methods, spraying the bacteriophage solution over the matrix is preferred.

The antibacterial composition comprising immobilized bacteriophages, or phage components, and matrix may be dried at a temperature from about 0° C. to about 50° C. or any amount therebetween, for example at a temperature of 0, 2, 4, 6, 8, 10, 12, 14, 16, 18, 20, 22, 24, 26, 28, 30, 32, 34, 36, 38, 40, 42, 44, 46, 48, or 50° C., or any temperature therebetween. For example, the antibacterial composition may be dried at a temperature from about 10° C. to about 30° C., or any amount therebetween, or from about 15° C. to about 25° C. or any amount therebetween. The drying process may also be accelerated by providing a flow of air over or through the antibacterial composition. Alternatively, the drying may be performed by heating the immobilized material under vacuum.

After a period of drying, additional aqueous solution may be applied to the matrix if desired, and the matrix re-dried. This process may be repeated as required to obtain the desired amount of phage on the matrix.

The immobilized bacteriophages composition of the present invention exhibits desirable storage properties and may be mixed with the feed of livestock, birds, poultry, domestic animals, fish, shellfish, and the like, to aid in reducing the shedding of target bacteria. Protected immobilized bacteriophages and/or phage components, for example but not limited to, encapsulated immobilized phages and/or phage components, may be mixed with other additives or supplements and added, as needed, to animal feed as part of the daily feed regime. Thus, settling of the bacteriophages and/or phage components, or protected bacteriophages and/or phage components, in the feed can be avoided. Alternatively, the adhesion of bacteriophages and/or phage components, protected bacteriophages and/or phage components, or a combination thereof, to the feed may be enhanced to provide improved mixing and delivery.

The immobilized bacteriophages, phage components, or both, may be protected, and used in this protected form. By “protected” it is meant that the bacteriophages and/or phage components may be encapsulated, packaged within a soft-shelled capsule, for example a gelatin capsule, or admixed within a formulation for tablet preparation, for example a time-released tablet as is known in the art, as described below, and this protected form administered to an animal.

An example of a protected form of the bacteriophages, phage components, or both, includes but is not limited to bacteriophages, and/or phage components that are encapsulated prior to administration to an animal as a feed additive. By “encapsulated”, it is meant that the immobilized phages, or phage components, or both, are coated with a substance that increases the phages' resistance to the physico-chemical stresses of its environment. The immobilized phages, or phage components, may be coated with any substance known in the art, by any suitable method known in the art, for example, but not limited to that disclosed in US publication 2003/0109025 (Durand et al., which is incorporated herein by reference). In this method, micro-drops of the coating substance are injected into a chamber containing one, or more than one immobilized bacteriophage strain, and/or phage components, of the present invention and rapidly cooled. Alternatively, a coating composition may be admixed with the one, or more than one immobilized bacteriophage, and/or phage components, of the present invention, with constant stirring or agitation, and cooled or dried as required.

The coating substance may be any suitable coating substance known in the art. For example, but without wishing to be limiting, the coating substance may comprise a substance with a melting temperature between about 20° C. and about 100° C., for example between about 30° C. and about 80° C., or any temperature therebetween; for example, the melting temperature may be 20, 22, 24, 26, 28, 30, 32, 34, 36, 38, 40, 42, 44, 46, 48, 50, 52, 54, 56, 58, 60, 62, 64, 66, 68, 70 72, 74, 76, 78, 80, 82, 84, 86, 88, 90, 92, 94, 96, 98, or 100° C., or any temperature therebetween. If the coating substance is to be ingested or used for an oral application, then it is preferred that the substance is a food grade substance. Non-limiting examples of such substances include vegetable fatty acids, fatty acids such as palmitic acid and stearic acid, for example Stéarine™, animal waxes, vegetable waxes, for example Carnauba wax and wax derivatives. However, the immobilized bacteriophage, or phage components, of the present invention may also be coated with other substances that are not food grade, depending on the intended use for the immobilized bacteriophage, or phage components. Other additive molecules may be added to the coating substance; such additive may include antioxidants, sugars, proteins or other synthetic material.

Additional coating substances may also be used for encapsulation, for example, non lipid-based materials (see for example, U.S. Pat. Nos. 6,723,358; and 4,230,687, which are incorporated herein by reference), for example sugars or other carbohydrate-based components that are water-soluble. The bacteriophage, or phage component, or both, in the composition of the present invention may also be coated with other substances that are not food grade. Other additive molecules may be added to the coating substance; such additives may include antioxidants, sugars, proteins or other synthetic material.

The process of lipid-based encapsulation protects the bacteriophages, phage components, or both, to some extent from a harsh environment the bacteriophages or components may be exposed to, for example, the low pH environment over a range of conditions found within the digestive system of an animal. The lipid-based material selected for encapsulation should also exhibit the property that it breaks down within a desired environment so that the bacteriophages and/or phage components are released. For example, digestive enzymes may degrade the encapsulating material and assist in the release of the bacteriophages and/or phage components within the gut of an animal, or animal waste after passage through the animal.

Several materials for encapsulating the bacteriophages or phage components, or both, may be used so that if desired, there is selected release within an animal at various places along the digestive tract including the gut, and release after passage through the digestive tract, while at the same time, if desired, protecting a portion of the bacteriophage or phage components for use downstream, for example within a primary holding tank for liquid manure. In addition, bacteriophage and/or phage components that are encapsulated using non-lipid based materials will dissolve in water, releasing bacteriophages and/or phage components immediately, or soon after exposure to an aqueous environment. In this manner, a release of bacteriophage, or phage components, or both may be obtained throughout the digestive tract and within manure, to ensure effective treatment of the pathogen in the animal and in manure.

The bacteriophage and/or phage components may also be protected within a tablet or capsule and released in a controlled manner depending upon the formulation selected. Capsule or tablet formulations may assist in the timed release of the bacteriophage or phage components within the animal. By “capsule” or “capsule form”, it is meant that the immobilized phages, or phage components, or both, are provided in a soft capsule that may be solubilized within an aqueous environment, or digested by enzymes within the digestive tract of an animal. The soft capsule may be made of any suitable substance known in the art, for example, but not limited to gelatin.

The immobilized or lyophilized bacteriophages, or phage components, or both may also be provided in a tablet form. By “tablet form”, it is meant that the immobilized phages, or phage components, or both, are provided in a pressed tablet that dissolves in an aqueous environment or digested by enzymes within the digestive tract of an animal. The tablet may be made of any suitable substance known in the art, and formed by any suitable method known in the art. For example, the tablet may comprise binders and other components necessary in the production of a tablet as are known to one of skill in the art. The tablet may be an immediate release tablet, where the bacteriophages and/or phage components are released into the liquid feed upon dissolution of the tablet, or may comprise a timed-release composition, where the bacteriophages and/or phage components are released within an aqueous environment, including liquid feed, animal gut, manure, or both in a time-dependent manner. For examples of tablet formulations which are not to be considered limiting, see WO 02/45695; U.S. Pat. No. 4,601,894; U.S. Pat. No. 4,687,757, U.S. Pat. No. 4,680,323, U.S. Pat. No. 4,994,276, U.S. Pat. No. 3,538,214, US (which are incorporated herein by reference) for several examples of time-release formulations that may be used to assist in the time controlled release of bacteriophage or phage components within aqueous environments.

Therefore, the present invention provides un-encapsulated bacteriophage or phage components, and protected bacteriophages and/or phage components, for example, encapsulated bacteriophages and/or phage components, bacteriophages and/or phage components that are encapsulated with different materials, bacteriophage and/or phage components that are in a capsule or a table form, or a combination thereof, and these un-encapsulated or protected forms may be combined, and administered to an animal as described herein.

The present invention provides a process of treating animal waste by administering one, or more than one bacteriophage strain, or phage components, or both, to the livestock. In this embodiment, the one, or more than one bacteriophage strain, or phage components, or both, are to be immobilized, and protected, for example, they are encapsulated, prepared in a table or capsule form, or a combination thereof. The protected bacteriophages can be admixed to animal feed as an additive, or in a mixture with feed supplements. The animal feed may be selected from the group consisting of a bird feed, a fish feed, a porcine feed, a livestock feed, a poultry feed, a domestic animal feed, and a food for aquaculture.

Without wishing to be bound by theory, when a protected form of the bacteriophage and/or phage component is exposed to the environment of the stomach or other regions of the digestive tract, proteases degrade the protected material in vivo, for example encapsulated, table or capsule form, or a combination thereof, and expose the immobilized bacteriophages to the environment. This releases the bacteriophages into the animal's gut thereby clearing one or more than one target pathogen from the animal's gut. Additionally, the bacteriophages may be cleared into the animal's waste, thus providing a two-fold treatment of the manure. By using un-encapsulated, encapsulated, capsule forms, tablet forms, or a combination thereof, the bacteriophage and/or phage component may be released within a desired compartment of the animal, for example the gut, be released in a continuous manner within the animal throughout the digestive tract, be released after passage through the animal within the manure, or a combination thereof.

The process of the present invention may also include further treatment of the animal waste ex vivo by addition of bacteriophages to the animal waste once it has been cleared by the livestock. The one, or more than one bacteriophage strain, and/or phage components, added at this juncture can be provided in solution, or immobilized onto a matrix, as previously described. The one, ore more than one bacteriophage strain, and/or phage components, can be added to the animal waste at any point in the handling of the manure: during collection of the manure, during liquefaction of the manure, during pumping of the liquefied manure, while the liquefied manure is in a primary storage tank, or any combination thereof.

For example, the one or more than one bacteriophage and/or phage component may also be added directly to a primary storage tank of manure at in any amount effective for reducing the population of target pathogen in the manure. More specifically, the bacteriophages can be administered at a dosage in the range of about 10⁵ to about 10¹³ pfu/gram, or any amount therebetween; for example, the dosage may be about 10⁵, 10⁶, 10⁷, 10⁸, 10⁹, 10¹⁰, 10¹¹, 10¹² or 10¹³ pfu/gram. Liquid bacteriophage, immobilized and/or protected bacteriophage or phage components may be used for treatment of manure within the primary storage tank.

The present invention also provides a method for reducing a population of one, or more than one target pathogen present in a livestock operation comprising, providing one or more than one protected bacteriophage strain, or phage component, or both, to animal feed, to an animal, to animal waste, liquid manure or a combination thereof, wherein the one, or more than one protected bacteriophage strain, or phage component, or both, is released within the animal feed, the animal, animal waste, the liquid manure, or a combination thereof, and kills the one or more than one target pathogen, thereby reducing the population of one or more than one target pathogen in the livestock operation. The one, or more than one protected bacteriophage strain, and/or phage components, may be administered in a treatment dosage of about 10⁷ to about 10¹³ pfu/animal/day, or any amount therebetween; for example, administration may be at 10⁷, 10⁸, 10⁹, 10¹⁰, 10¹¹, 10¹², or 10¹³, pfu/animal/day. Alternatively, the one or more than one encapsulated immobilized bacteriophage strain, and/or phage components, may be administered in a maintenance dosage of about 10⁵ to about 10⁸ pfu/animal/day, or any amount therebetween; for example, administration may be at 10⁵, 10⁶, 10⁷, or 10⁸pfu/animal/day. In yet another alternative, the one or more than one encapsulated immobilized bacteriophage strain, and/or phage components, may initially be administered in a treatment dosage of about 10⁷ to about 10¹³ pfu/animal/day, or any amount therebetween, followed by a maintenance dosage of about 10⁵ to about 10⁹ pfu/animal/day, or any amount therebetween.

Thus, the present invention provides a use of one or more than one un-encapsulated or protected bacteriophage and/or phage component for delivery to animal manure to prevent the spread of bacterial infections through the manure. The one or more than one bacteriophage may be delivered directly to the manure (ex vivo) in an un-encapsulated form, or may be administered to the animal in a protected form for delivery to the manure through the animal's gut.

The presence of bacteriophages against a target pathogen in the manure may be beneficial in preventing the spread of bacterial infections caused by various pathogens. In addition to reducing the spread of E. coli O157:H7, which can cause serious health issues in humans, bacteriophages can also reduce the counts of Staphylococcus aureus, which can infect the teats and udder of cattle and cause mastitis. In addition, Treponema infections, causing hoof disease, may be treated in this manner by acting as a foot bath when the animals are walking in the pen.

The present invention will be further illustrated in the following examples.

### EXAMPLES

### Example 1

### Isolation, Amplification and Titration of Phase

Bacteriophages were isolated from manure samples obtained from dairy and beef farms across Canada. Manure samples were allowed to react with E. coli O157:H7 and plated onto agar plates. Any phage plaques obtained were isolated and purified as per standard phage purification protocols (Maniatis et al (1982) Molecular cloning: a laboratory manual, Cold Spring Harbor Laboratory, Cold Spring Harbor, N.Y.).

Purified phages isolated as outlined above were amplified using the isolation strain of E. coli O157:H7. Purified phage and bacteria were mixed together, let stand at room temperature for 10 minutes, and amplified according to standard protocols commonly used in the art (Maniatis et al (1982) Molecular cloning: a laboratory manual, Cold Spring Harbor Laboratory, Cold Spring Harbor, N.Y.). Amplified samples in LB broth were filter sterilized and used.

Concentrations of bacteriophage solutions were determined using standard phage titration protocols (Maniatis et al (1982) Molecular cloning: a laboratory manual, Cold Spring Harbor Laboratory, Cold Spring Harbor, N.Y.). Preparations containing phages were diluted with LB, mixed and incubated with E. coli O157:H7 for 10 minutes and plated onto agar plates. The concentration of phages was determined from the number of plaques obtained at the different dilutions and multiplying with the appropriate dilution factor.

### Example 2

### Immobilization of Phases

E. coli O157:H7 specific phages P10 and R4, prepared as described in example 1, were immobilized on two different matrices: powdered milk (fat free) and soya protein. Both milk powder (Carnation) and soya protein (Supro) were obtained off-the-shelf from local food stores. Identical protocols were used for both materials and for other phages.

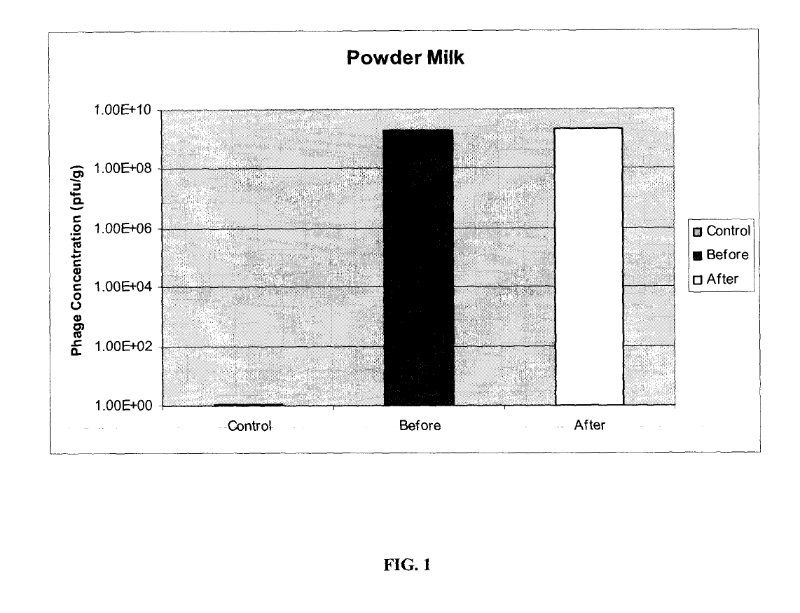

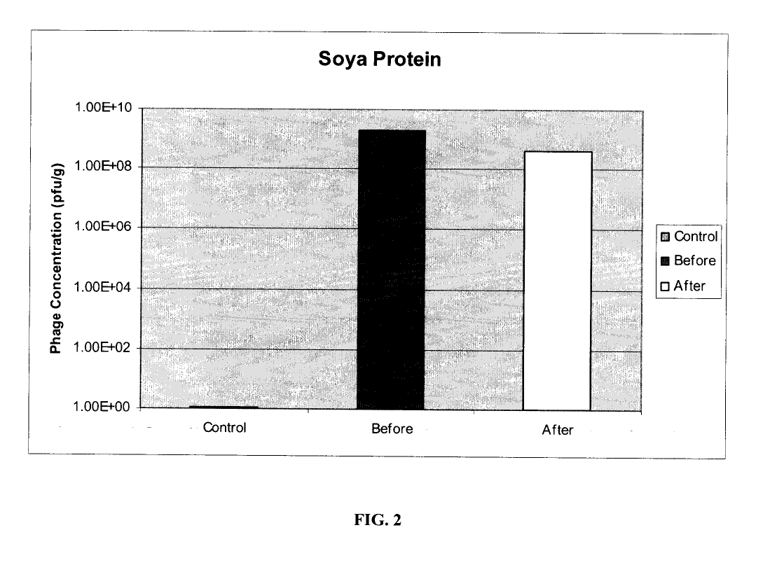

50 g of powder (powdered milk or soya protein) was spread in a glass dish. Phages in solution were uniformly sprayed onto each powdered matrix. Varying titers of phages, ranging from 10⁵ pfu/g to 10⁹ pfu/g, were used with powdered milk, each yielding similar results. The phage-powder was mixed and dried at 37° C. for 2 hours, or until completely dried. The resulting bacteriophage composition was ground into a fine powder, with particle sizes in the range of 50-600 μm and an average particle size of 200 μm. 0.5 grams of each powdered bacteriophage composition was re-suspended in 10 ml of reverse-osmosis (RO) water and the recovery of phages tested. Powdered milk or powdered soya protein in the absence of bacteriophages was used as a control. The results for bacteriophage compositions prepared using dry milk power as the matrix are presented in FIG. 1. Results for bacteriophage compositions prepared using soy protein as the matrix are presented in FIG. 2.

For phage immobilized on powdered milk, the results show that phage can be recovered from the bacteriophage composition and no loss in activity is observed. FIG. 1 shows that the phage titer obtained after immobilization (“After”) is similar to the amount of phage added to the powder (“Before”). Similar results are observed for bacteriophage compositions comprising soy protein (FIG. 2; “After”: immobilized phage; “Before” amount of phage added to matrix).

These results also show that immobilized phages are readily released from a matrix when introduced to an aqueous medium. The results shown in FIGS. 1 and 2 are for phage against E. coliO157:H7, the same results are obtained with bacteriophage directed to Salmonella and Campylobacter.

### Example 3

### Encapsulation of Bacteriophage Compositions

Bacteriophage compositions were prepared as described in Example 2, and encapsulated generally as described in US publication 2003/0109025 (which is incorporated herein by reference), with some modifications to preserve the activity of the phages. Briefly, 400 g of immobilized phage and 1.2 kg of vegetable fatty acids were used for encapsulation. The maximum temperature attained by the encapsulated phage preparation was 39° C.

Once the coating operation was complete, the encapsulated immobilized phage particles were collected and stored in airtight containers. The average particle size was between 100 and 1000 μm.

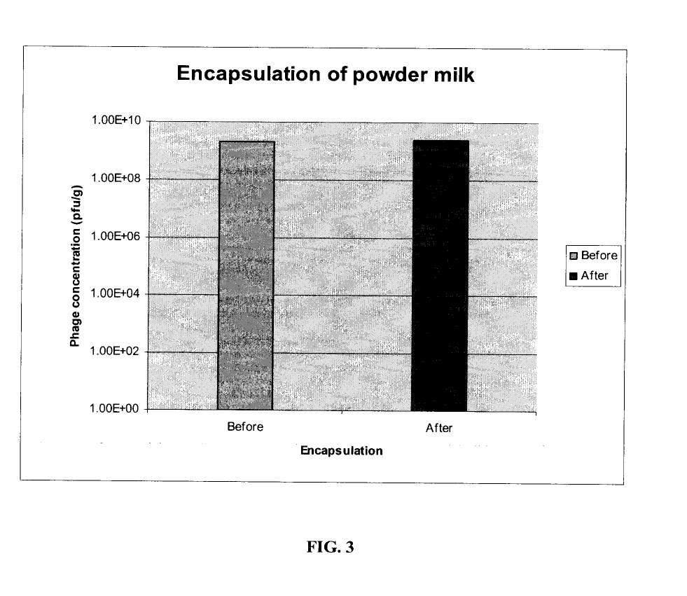

The effect of encapsulation on the titer of bacteriophage compositions immobilized on milk powder was determined by determining the activity of the immobilized phage preparation before (“Before”, FIG. 3) and after (“After”, FIG. 3) encapsulation. For this analysis, encapsulated bacteriophages were re-suspended, and ground using a blender. The re-suspended encapsulated bacteriophages were blended in order to disrupt the encapsulated particles and release the bacteriophages. 0.5 g of encapsulated immobilized phage was mixed with 45.5 ml of re-suspension media (L B Broth or R O Water), and 250 μl of antifoam agent was added to prevent foaming upon grinding. The results of this analysis are shown in FIG. 3.

These results demonstrate that bacteriophages can be recovered from an encapsulated bacteriophage composition, and encapsulation does not inactivate the immobilized phage. The results shown in FIG. 3 are for phage directed to E. coli O157; similar results are obtained with bacteriophages directed to Salmonella and Campylobacter.

### Example 4

### Stability and Release of Encapsulated Bacteriophages

Phages were immobilized and encapsulated as described in Example 3. The release of encapsulated immobilized phages upon physical or chemical disruption was tested in the following manner: 0.5 g of encapsulated immobilized phage was mixed with 45.5 ml of re-suspension media (L B Broth or R O Water). 250 μl of antifoam agent was used to prevent foaming upon grinding. A control sample of encapsulated immobilized phages was prepared as described above, but not subjected to grinding, to determine the non-specific leaching of encapsulated bacteriophages within the re-suspension medium.

The stability of the encapsulated bacteriophages at low pH was also examined. After re-suspension (as outlined above), the encapsulated immobilized phages were incubated for 30 or 60 min at pH 2.15, neutralized to pH 7.0 using NaOH, then ground using a blender; another sample (control) was resuspended and immediately ground. Both the control and test samples were filter sterilized using a 0.45 μm syringe filter prior to use.

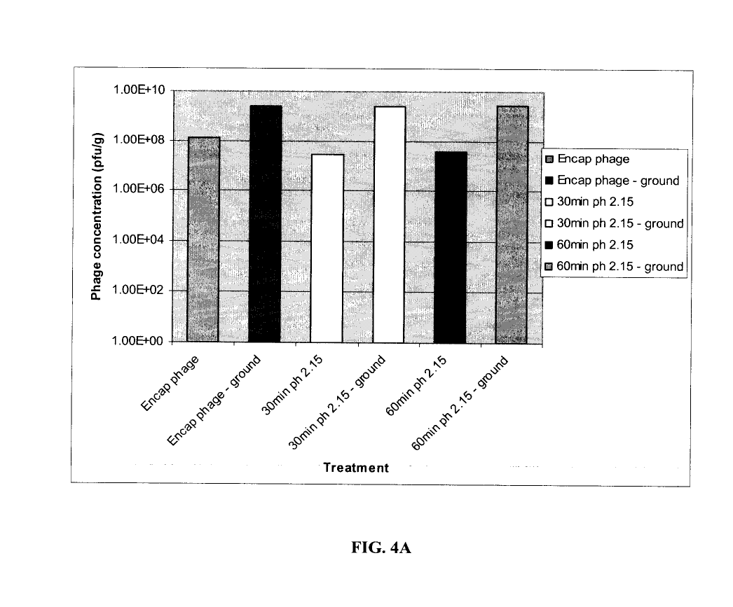

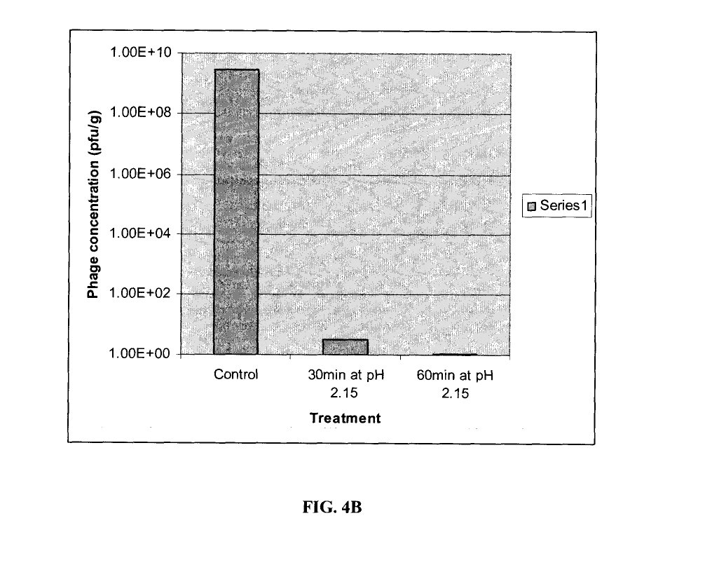

FIG. 4A shows the results of these analyses. The data show that resuspension of the encapsulated immobilized phages results in phage concentrations of about 1×10⁷ pfu/g. Similarly, incubation of the phages at pH 2.15 alone does not cause significant release of phages (phage concentration of about 1×10⁷ pfu/g after 30 minutes, or a phage concentration of about 3×10⁷ pfu/g after 60 minutes). However, following grinding and disruption of the encapsulated bacteriophage particles, the amount of phage released is about the same amount as was loaded onto the milk powder for immobilization (about 5×10⁹ pfu/g). Incubation of non encapsulated and non immobilized phages at pH 2.15 for 30 and 60 minutes however resulted in essentially complete loss of phage infectivity (FIG. 4B).

These results demonstrate that bacteriophages may be released following disruption of encapsulated bacteriophage particles. Furthermore, these results show that encapsulated bacteriophages may be exposed to a pH of 2.15 for prolonged period of time, with little or no loss in activity (titer). The results for non-encapsulated and non-immobilized bacteriophages are consistent with the results of Jepson and March (2004, Vaccine, 22:2413-2419), where a dramatic loss of viability of bacteriophages was observed after only 5 minutes at pH below pH 2.2. This loss in activity is obviated by encapsulation of the bacteriophages as described in the present invention.

The results shown in FIGS. 4A and 4B are for phage directed to E. coli similar results are obtained with bacteriophages directed to Salmonella and Campylobacter.

### Example 5

### Stability of Immobilized Phase

Bacteriophages were immobilized on a matrix, in this case milk powder as described in Example 2 and the material was stored at either room temperature (RT) or at 4° C. (4C) in airtight containers. Samples were obtained at different time points, and phage titers determined, over a period of 10 months. The initial phage concentration was 3×10⁶ pfu/g.

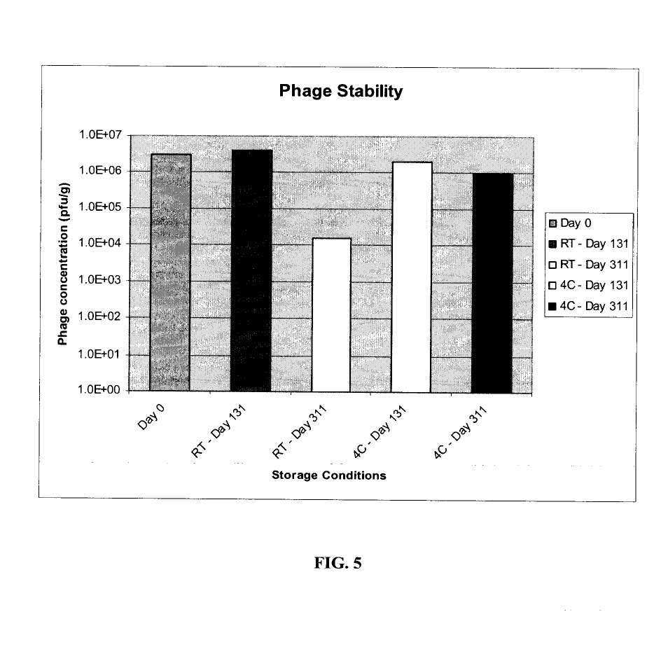

FIG. 5 shows that the immobilized phages (bacteriophage composition) are stable at either room temperature or 4° C. for at least 131 days (4.5 months), and is stable for at least 311 days (10 months) at 4° C. Addition of a desiccant, or storage of the bacteriophages in a desiccated environment may further increase the viability of the bacteriophage composition.

### Example 6

### Delivery of Active Bacteriophages

The delivery of E. coli O157specific bacteriophages was demonstrated as part of a 5 day single treatment dose study using encapsulated phages. The treatment dose used in this study was 10¹⁰ pfu/animal/day. The phages were encapsulated as previously described in Example 3. The encapsulated phages, which may also be tableted, were then mixed with other supplements and added to animal feed in an amount of about 1-50 g per animal per dose. When administered this way, the bacteriophage dose is available to the animal over a 24 hr period. The encapsulated phage preparation was given to the animal once per day for 5 days. Alternatively, a maintenance dose may be given to the animal every 1-3 days

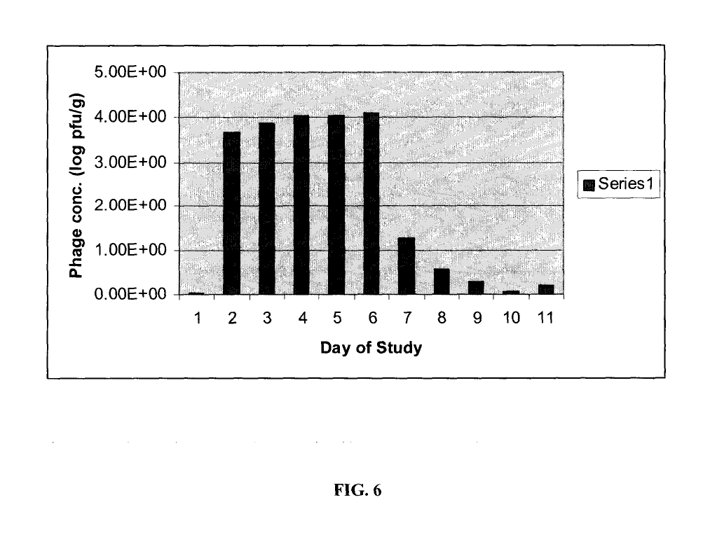

Analysis of the animal's manure reveals an increase in free bacteriophage concentration in the manure from these animals (see FIG. 6), indicating that active bacteriophages are delivered to the gut of these animals. The phage levels increased on day 2 and stayed at the high level for the next 4 days. The phage levels returned to background levels in the next 24-48 hrs. This also results in a decrease in the E. Coli O157in the animals (data not shown).

### Example 7

Treatment of Manure Contaminated with E. coli O157:H7—Small Scale

A representative experiment for the treatment of manure contaminated with E. coli O157:H7 by bacteriophages is presented here.

Bacteriophages against E. coli O157:H7 isolated from a dairy farm in Ontario were used in these studies. Solid manure (40 g) obtained from a local farm was diluted with 40 ml of tap water and used for this study. The slurry was first evaluated for the presence of E. coli O157:H7 bacteria as well as phages against this pathogen. It was negative for both. The manure slurry was then spiked with 10⁶ colony forming units (cfu) of E. coli O157:H7 bacteria. The mixture was treated with a bacteriophage (107A) available from Gangagen Life Sciences Inc. Three different concentrations of bacteriophage (10², 10⁴ and 10⁶ plaque forming units (pfu)) were used in this study. The bacterial count was determined at 0, 2 and 4hrs. The experiment was carried out both at 37° C. and room temperature.

Treatment of the sample with 10⁶ pfu of bacteriophages for 2 hrs at 37° C., resulted in a 2 log decrease in the bacterial count in the sample. No bacteria were detected after 4 hr incubation at this temperature. The effect was less pronounced at 10⁴ pfu and 10² pfu of bacteriophages.

Treatment of the sample at room temperature resulted in a reduced efficacy of the phage preparation used in this study. Under these conditions, the phage was able to reduce the bacterial count by 2 logs after incubation for 4 hrs with 10⁶ pfu of phage. The effect with 10⁴ and 10² pfu of phages was less pronounced. Application of phages having amplification characteristics best suited for this application will improve the efficacy of this treatment. The dose required as well as the treatment time may be modified as required to obtain the desired treatment effect.

### Example 8

Treatment of Manure Contaminated with E. coli O157:H7—Larger Scale Analysis

Two representative experiments for the treatment of manure contaminated with E. coli O157:H7 by bacteriophages are presented, one using 200 mL of manure (A), the second using 5 L of manure (B).

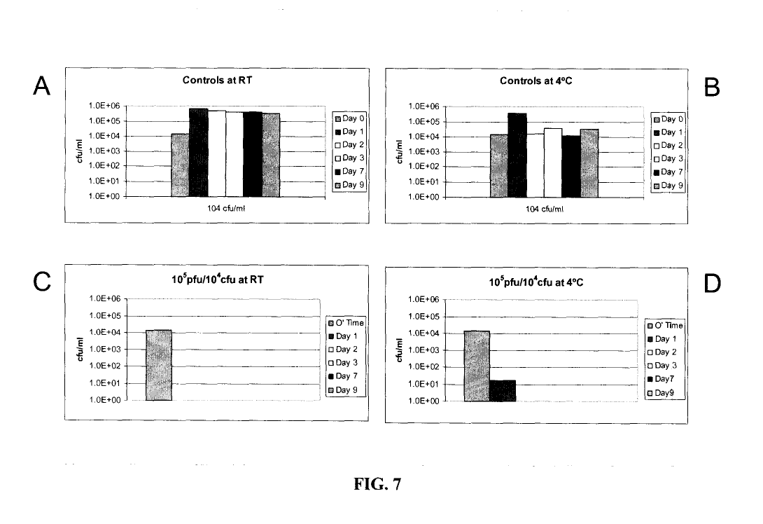

(A) In the first study, the effect of temperature on the activity of phages in manure was observed. 200 ml of manure was spiked with E. coli O157:H7 at a concentration of 10⁴cfu/ml. After addition of the phage at 10⁵pfu/ml, the manure was left at either room temperature or in a refrigerator (4° C.), and stirred occasionally throughout the day. Samples were analyzed for E. coli O157:H7, total E. coli and phage. As shown in FIG. 7, upon treating the manure with phage, the E. coli O157:H7 count was below detection within 1 day when treatment was done at room temperature. However, when treatment was carried out at 4° C., the effect was delayed by one day, with the E. coli O157:H7 count below detection within 48 hrs. In both cases, the total E. coli counts did not change significantly.

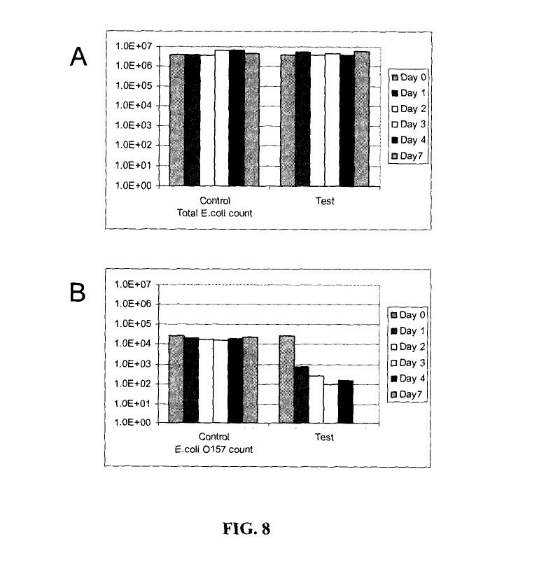

(B) In the second study, the 5 L manure sample was spiked with Ec4 (an E. coli O157:H7 strain in the Gangagen Life Sciences Inc. collection). The manure was then treated with phage R4 at a concentration of 10⁵cfa/ml (FIG. 8) and left at room temperature without stirring. Samples were analysed for E. coli O157:H7, total E. coli and phage. A stepwise decrease in the E. Coli O157:H7 bacterial count was observed, and was below detection limits by day 7. Total E. coli count, however, was the same in both the treated and control samples. No significant change in the bacteriophage count was observed in this study.

### Example 9

Treatment of Manure Contaminated with E. coli O157:H7—Pilot Scale Efficacy Study

A pilot scale study was performed to determine the efficacy of the phage preparation.

For this study, 1 ton of liquid manure negative for E. coli O157:H7 and very low in phages specific to this pathogen was obtained from a local dairy farm and spiked with E. Coli O157 to a final concentration of 10⁴ cfu/ml. The pathogen was allowed to acclimatize to the manure for 48 hrs prior to phage treatment. E. coli O157:H7-specific phages were added to a final concentration of 10⁸ pfu/gm. The phages were mixed in and the manure was left undisturbed throughout the study, so as to simulate conditions in a manure lagoon. Samples were collected periodically, with minimal agitation, over the next 18 days and the bacterial and phage counts determined.

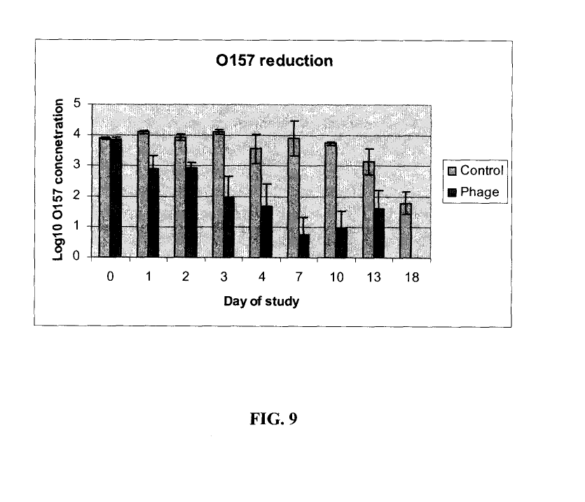

The results are shown in FIG. 9. A decrease of greater than 2 log in bacterial count was observed in the phage-treated sample by day 3 as compared to the control manure, which contained only bacteria. This significant decrease continued over the next several days, and the bacterial count was below detection by the end of the study period. This data indicates that using phages to treat dairy manure will help reduce the pathogen prior to spreading.

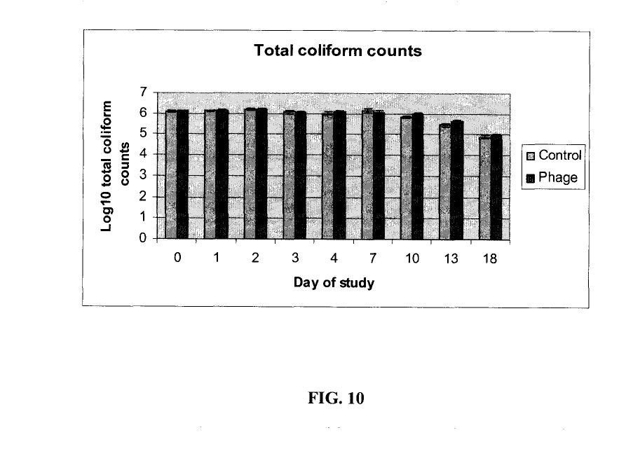

The total coliform counts were also monitored during the study. The results are presented in FIG. 10. No difference was observed between phage treated and control manure samples, further proving the specificity of Gangagen Life Sciences Inc. phage preparations. Using this approach helps maintain the normal beneficial bacterial flora in the manure, thus retaining its nutritive value.

All citations are hereby incorporated by reference.
The present invention has been described with regard to one or more embodiments. However, it will be apparent to persons skilled in the art that a number of variations and modifications can be made without departing from the scope of the invention as defined in the claims.

1: A process for reducing a population of one or more than one target pathogen in animal waste comprising, administering one or more than one protected bacteriophage strain, phage tail, or a combination thereof to an animal, where the one, or more than one protected bacteriophage strain, phage tail, or a combination thereof is released in vivo, kills the one or more than one target pathogen, ffand acts to clear the one or more than one target pathogen from the gut of the animal thereby reducing the population of one or more than one target pathogen in the animal waste.

2: The process of claim 1, wherein the one or more than one protected bacteriophage strain is administered in a treatment dosage of about 10⁷ to about 10¹³ pfu/animal/day.

3: The process of claim 1, wherein the one or more than one protected bacteriophage strain is administered in a maintenance dosage of about 10⁵ to about 10¹⁰ pfu/animal/day.

4: The process of claim 1, wherein the one or more than one protected bacteriophage strain is initially administered in a treatment dosage of about 10⁷ to about 10¹³ pfu/animal/day, followed by a maintenance dosage of about 10⁵ to about 10¹⁰ pfu/animal/day.

5: The process of claim 1, wherein the one or more than one protected bacteriophage or phage tail comprises, encapsulated bacteriophage or phage tail, immobilized encapsulated bacteriophage or phage tail in a capsule form, immobilized encapsulated bacteriophage or phage tail in a tablet form, un-encapsulated immobilized bacteriophage or phage tail in a capsule form, un-encapsulated immobilized bacteriophage or phage tail in a tablet form, un-encapsulated bacteriophage or phage tail immobilized on a matrix, lyophilized bacteriophage or phage tail, or any combination thereof.

6: The process of claim 5, wherein the matrix is selected from the group consisting of skim milk powder, soya protein, albumin powder, single cell proteins, trehalose, manitol, sugar, sugar alcohol, other water-soluble carbohydrate-based materials, synthetic plant-derived plastic, and a combination thereof.

7: The process of claim 5, wherein the one or more than one protected bacteriophage strain, phage tail, or a combination thereof is encapsulated using a material selected from the group consisting of vegetable fatty acids, fatty acid, stearic acid, palmitic acid, an animal wax, a vegetable wax, Camauba wax, and a wax derivative.

8: The process of claim 5, wherein the one or more than one protected bacteriophage strain, phage tail, or a combination thereof is encapsulated using a material selected from the group consisting of sugars and soluble non lipid-based materials.

9: The process of claim 1, wherein a phage protein is administered in addition to the one or more than one protected bacteriophage strain, phage tail, or a combination thereof.

10: The process of claim 1 further comprising a step of treating the animal waste ex vivo with an additional dosage of the one or more than one bacteriophage strain, or phage tails.

11: The process of claim 10, wherein the animal waste is manure and wherein in the step of treating the manure ex vivo, the one or more than one bacteriophage strain, phage tail, or a combination thereof is added to the manure while the manure is being liquefied, while the liquified manure is being pumped, while the liquid manure is in a primary storage tank, in the treatment of fecal waste from poultry and aquaculture operations, or any combination thereof.

12: The process of claim 10, wherein in the step of treating, the one or more than one bacteriophage strain is added to the animal waste at an amount between about 10⁵ to about 10¹⁰ pfu per gram.

13: A process for reducing a population of one or more than one target pathogen present in animal waste, comprising, providing one or more than one protected bacteriophage strain, phage tail, or a combination thereof to the animal waste for a time sufficient where the one or more than one protected bacteriophage strain, phage tail, or a combination thereof is released within the animal waste and kills the one or more than one target pathogen, thereby reducing the population of one or more than one target pathogen in the animal waste.

14: The process of claim 13, wherein the animal waste is liquid manure.

15: The process of claim 14, wherein in the step of providing, the one or more than one bacteriophage strain, phage tail, or a combination thereof is added to the liquid manure while the manure is being liquefied, while the liquefied manure is being pumped, while the liquid manure is in a primary storage tank, or any combination thereof.

16: The process of claim 14, wherein in the step of providing, the one or more than one bacteriophage strain is added to the liquid manure at an amount between about 10⁵ to about 10 pfu per gram.

17: The process of claim 13, wherein the one or more than one protected bacteriophage phage tail, or a combination thereof, comprises, encapsulated bacteriophage or phage tail, immobilized encapsulated bacteriophage or phage tail in a capsule form, immobilized encapsulated bacteriophage or phage tail in a tablet form, un-encapsulated immobilized bacteriophage or phage tail in a capsule form, un-encapsulated immobilized bacteriophage or phage tail in a tablet form, un-encapsulated bacteriophage or phage tail immobilized on a matrix, lyophilized bacteriophage or phage tail, or any combination thereof.

18: The process of claim 17, wherein the matrix is selected from the group consisting of skim milk powder, soya protein, albumin powder, single cell proteins, trehalose, manitol, sugar, sugar alcohol, other water-soluble carbohydrate-based materials, and a combination thereof.

19: The process of claim 17, wherein the one or more than one protected bacteriophage strain, phage tail, or a combination thereof is encapsulated using a material selected from the group consisting of vegetable fatty acids, fatty acid, stearic acid, palmitic acid, an animal wax, a vegetable wax, Carnauba wax, and a wax derivative.

20: The process of claim 17, wherein the one or more than one protected bacteriophage strain, phage tail, or a combination thereof is encapsulated using a material selected from the group consisting of sugars and soluble non lipid-based materials.

21: The process of claim 13, wherein a phage protein is administered in addition to the one or more than one protected bacteriophage strain, phage tail, or a combination thereof.

22: A process for reducing a population of one, or more than one target pathogen present in a livestock operation comprising, providing one or more than one protected bacteriophage strain, phage tail, or a combination thereof to animal feed, to an animal, to animal waste, to liquid manure or a combination thereof, wherein the one, or more than one protected bacteriophage strain, phage tail, or a combination thereof is released within the animal feed, the animal, the animal waste, the liquid manure, or a combination thereof, and kills the one or more than one target pathogen, thereby reducing the population of one, or more than one target pathogen in the livestock operation.

23: The process of claim 22, wherein the one or more than one protected bacteriophage, phage tail, or a combination thereof comprises, encapsulated bacteriophage or phage tails, immobilized encapsulated bacteriophage or phage tail in a capsule form, immobilized encapsulated bacteriophage or phage tail in a tablet form, un-encapsulated immobilized bacteriophage or phage tail in a capsule form, un-encapsulated immobilized bacteriophage or phage tail in a tablet form, un-encapsulated bacteriophage or phage tail immobilized on a matrix, lyophilized bacteriophage or phage tail, or a combination thereof.

24: The process of claim 23, wherein the matrix is selected from the group consisting of skim milk powder, soya protein, albumin powder, single cell proteins, trehalose, manitol, sugar, sugar alcohol, other water-soluble carbohydrate-based materials, synthetic plant-derived plastic, and a combination thereof.

25: The process of claim 23, wherein the one or more than one protected bacteriophage strain, phage tail, or a combination thereof is encapsulated using a material selected from the group consisting of vegetable fatty acids, fatty acid, stearic acid, palmitic acid, an animal wax, a vegetable wax, Carnauba wax, and a wax derivative.

26: The process of claim 23, wherein the one or more than one protected bacteriophage strain, phage tail, or a combination thereof is encapsulated using a material selected from the group consisting of sugars and soluble non lipid-based materials.

27: The process of claim 22, wherein a phage protein is administered in addition to the one or more than one protected bacteriophage strain, phage tail, or a combination thereof.

28: The process of claim 1, wherein the animal waste is livestock manure.

29: A process for preventing the spread of infections in an animal caused by one or more than one target pathogen, the method comprising administering one or more than one bacteriophage strain, phage tail, or both, to the animal, such that the one, or more than one bacteriophage strain, phage tail, or both, is released within the digestive tract of the animal, and attach to and kill the target pathogen, thereby reducing the population of the one or more than one target pathogen within animal waste.

30: The process of claim 29, wherein the target pathogen is E. coli O157:H7, Staphylococcus aureus, Treponema, or another pathogen carried in the gastrointestinal tract, or a combination thereof.

31: The process of claim 29 or 30, wherein the one or more than one bacteriophage strain, phage tail, or both, is provided as a time-release formulation.

32: The process of claim 14, wherein the one or more than one protected bacteriophage phage tail, or a combination thereof, comprises, encapsulated bacteriophage or phage tail, immobilized encapsulated bacteriophage or phage tail in a capsule form, immobilized encapsulated bacteriophage or phage tail in a tablet form, un-encapsulated immobilized bacteriophage or phage tail in a capsule form, un-encapsulated immobilized bacteriophage or phage tail in a tablet form, un-encapsulated bacteriophage or phage tail immobilized on a matrix, lyophilized bacteriophage or phage tail, or any combination thereof.

33: The process of claim 14, wherein a phage protein is administered in addition to the one or more than one protected bacteriophage strain, phage tail, or a combination thereof.

34: The process of claim 30, wherein the one or more than one bacteriophage strain, phage tail, or both, is provided as a time-release formulation.
